(19) United States
(12) Patent Application Publication
(10) Pub. No.: US 2015/0233094 A1
(43) Pub. Date: Aug. 20, 2015

(54) Wheel Assist Drive with Traction Control System and Method

(71) Applicant: Caterpillar, Inc., Peoria, IL (US)

(72) Inventor: Sudarshan Aravamuthan Maiyur, Cary, NC (US)

(73) Assignee: Caterpillar, Inc., Peoria, IL (US)

(21) Appl. No.: 14/181,839

(22) Filed: Feb. 17, 2014

(51) Int. Cl. E02F 9/22; F16H 61/00; B60K 17/356

(52) U.S. Cl. CPC E02F 9/2246; B60K 17/356; F16H 61/0025; F16H 2061/0034

(57) ABSTRACT

A wheel assist drive system and method are provided for use on a machine, such as a motor grader. The wheel assist drive system includes a free-wheeling valve for providing all-wheel drive, a flow divider valve for providing traction control, and a bypass valve for selectively bypassing the flow divider valve. Operation of the bypass valve is based on the status of the free-wheeling valve to reduce heat generation and losses attributable to hydraulic fluid flow through the flow divider valve.

### TECHNICAL FIELD

The present disclosure generally relates to wheel assist drives, and more particularly to actuation and control of a flow divider valve used in a front assist drive.

### BACKGROUND

Various types of machines employ a wheel assist drive to provide all-wheel driving in slippery conditions. A motor grader, for example, is typically used in off-road environments to perform ditch work, site preparation, and other surface contouring and finishing tasks where obtaining sufficient traction may be difficult. The motor grader will often have a first set of wheels (such as a pair of rear wheels) driven directly by a combustion engine or primary hydraulic pump. A second set of wheels (such as a pair of front wheels) are typically used for steering. The front wheels, however, may be driven by hydraulic assist motors that are part of a wheel assist drive that permits all-wheel driving.

The wheel assist drive may be selectively engaged so that the machine operates in all-wheel drive mode only when desired. For example, the machine may include a user interface that allows an operator to switch the wheel assist drive on or off. Additionally, or alternatively, a controller operably coupled to the wheel assist drive may automatically engage or disengage the wheel assist drive based on feedback indicative of the level of traction between the wheels and the surface.

Some previous wheel assist drives have been used in conjunction with a flow dividing valve to reduce front wheel slip. Without the flow dividing valve, when a first assist motor associated with a slipping wheel turns more rapidly, it draws an increased flow of hydraulic fluid. The increased flow to the slipping assist motor reduces hydraulic fluid flow to a second assist motor, which in turn reduces the rotational speed of the wheel that has traction. In excessive slip situations, substantially all of the hydraulic flow may be directed to the assist motor associated with the slipping wheel, thereby impacting the ability of the machine to travel over the surface. The flow dividing valve addresses the wheel slip condition by regulating hydraulic fluid flow to the two hydraulic assist motors coupled to the front wheels. In general, the flow dividing valve will regulate hydraulic pressures delivered to the assist motors by bringing those pressures closer to being equal. More specifically, the flow dividing valve senses hydraulic fluid pressures delivered to each of the hydraulic assist motors and, when a reduced pressure is sensed at one of the assist motors, the flow dividing valve adjusts to reduce hydraulic fluid flow to that assist motor, thereby improving fraction of the wheel associated with the other assist motor.

While the use of a flow dividing valve mitigates the wheel slip issue, hydraulic fluid flow through the flow dividing valve generates high heat loads and inefficiencies in the hydraulic system due to valve modulations losses. In some prior machines, the flow dividing valve is always active, thereby continuously generating excessive heat and hydraulic system inefficiency. Another system described in U.S. Pat. No. 5,647,211 to Harber et al. proposes a control scheme in which the operator may independently control activation of the all-wheel drive mode and a flow divider valve bypass. While the Harber et al. system may reduce heat generation and hydraulic system inefficiency as compared to a system having a continuously active flow dividing valve, it still permits unnecessary activation of the flow dividing valve and the problems attendant thereto.

### SUMMARY OF THE DISCLOSURE

In accordance with one aspect of the present disclosure, a method of controlling front wheel assist and traction control is provided for a machine having first and second wheel motors and a primary pump for circulating a hydraulic fluid. The method may include providing a flow divider valve having a flow divider inlet fluidly communicating with first and second flow divider outlets, the first flow divider outlet fluidly communicating with the first wheel motor and the second flow divider outlet fluidly communicating with the second wheel motor. A bypass valve may be provided upstream of the flow divider, the bypass valve having a bypass mode, in which at least a portion of hydraulic fluid is communicated around the flow divider valve to the first and second wheel motors, and a flow dividing mode in which the hydraulic fluid is communicated through the flow divider valve to the first and second wheel motors. A free-wheeling valve may be provided upstream of the bypass valve, the free-wheeling valve having a free-wheeling mode, in which fluid communication is prevented between the primary pump and the first and second wheel motors, and a drive assist mode, in which the primary pump fluidly communicates with the first and second wheel motors. The method may include determining an activation status of the free-wheeling valve, operating the bypass valve in the bypass mode when the free-wheeling valve is in the free-wheeling mode, and operating the bypass valve in either of the bypass mode and the flow dividing mode when the free-wheeling valve is in the drive assist mode.

In accordance with another aspect of the present disclosure, a method of controlling front wheel assist and traction control is provided on a machine having first and second wheel motors and a primary pump for circulating a hydraulic fluid. The method may include providing a flow divider valve having a flow divider inlet fluidly communicating with first and second flow divider outlets, the first flow divider outlet fluidly communicating with the first wheel motor and the second flow divider outlet fluidly communicating with the second wheel motor. A bypass valve may be provided upstream of the flow divider, the bypass valve having a bypass mode, in which at least a portion of hydraulic fluid is communicated around the flow divider valve to the first and second wheel motors, and a flow dividing mode in which the hydraulic fluid is communicated through the flow divider valve to the first and second wheel motors. A free-wheeling valve may be provided upstream of the bypass valve, the free-wheeling valve having a free-wheeling mode, in which fluid communication is prevented between the primary pump and the first and second wheel motors, and a drive assist mode, in which the primary pump fluidly communicates with the first and second wheel motors. The method may include initially setting the bypass valve to the bypass mode, determining an activation status of the free-wheeling valve, and operating the bypass valve the flow dividing mode when the free-wheeling valve is in the drive assist mode and traction control is active.

In accordance with another aspect of the present disclosure, a drive assist system is provided for a machine having a primary pump and first and second ground-engaging members. The drive assist system may include a first hydraulic motor operably coupled to the first ground-engaging member and a second hydraulic motor operably coupled to the second ground-engaging member. A free-wheeling valve may be disposed between the primary pump and the first and second wheel motors, the free-wheeling valve operable between a free-wheeling mode blocking fluid flow from the primary pump to the first and second wheel motors, and a drive assist mode permitting fluid flow from the primary pump to the first and second wheel motors. A flow divider valve may be disposed between the free-wheeling valve and the first and second wheel motors. A first bypass conduit may fluidly communicate with the first motor and around the flow divider valve member, and a second bypass conduit may fluidly communicate with the second motor and around the flow divider valve member. The system may further include a bypass valve disposed between the flow divider valve and the free-wheeling valve, the bypass valve having a flow dividing mode permitting fluid communication between the free-wheeling valve and the flow divider valve, and a bypass mode permitting fluid communication between the free-wheeling valve and the first and second bypass conduits. A controller may be operably coupled to the free-wheeling valve and the bypass valve and configured to determine an activation status of the free-wheeling valve, operate the bypass valve member in the bypass mode when the free-wheeling valve is in the free-wheeling mode, and operate the bypass valve member in either of the bypass mode and the flow dividing mode when the free-wheeling valve is in the drive assist mode.

### BRIEF DESCRIPTION OF THE DRAWINGS

FIG. 1 is a schematic side view of a motor grader within which one or more embodiments of the present disclosure may be implemented;

FIG. 2 is a schematic top view of a motor grader within which one or more embodiments of the present disclosure may be implemented;

FIG. 3 is a schematic diagram showing a wheel assist drive system of the motor grader constructed in accordance with an aspect of the disclosure; and

FIG. 4 is a flow chart showing a process of controlling traction control in a wheel drive assist system in accordance with an aspect of the disclosure.

### DETAILED DESCRIPTION

Embodiments of wheel assist drive system and method are disclosed for use on a machine. In the exemplary embodiments described herein, the machine is a motor grader. The wheel assist drive system includes a free-wheeling valve for providing all-wheel drive, a flow divider valve for providing traction control, and a bypass valve for selectively bypassing the flow divider valve. Operation of the bypass valve is based on the status of the free-wheeling valve to reduce heat generation and losses attributable to hydraulic fluid flow through the flow divider valve.

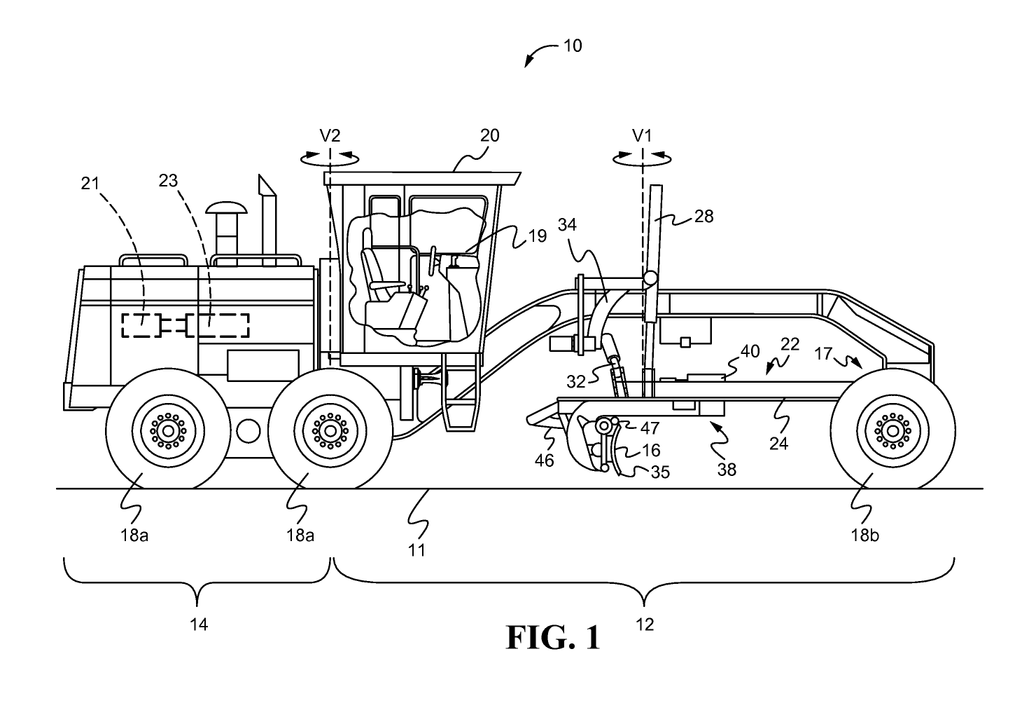

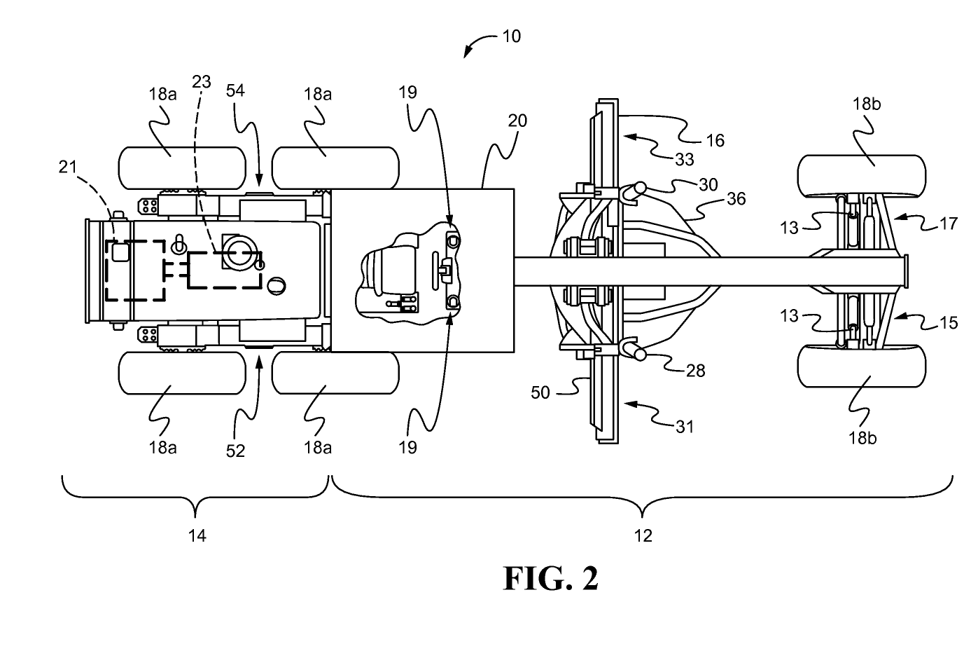

FIGS. 1 and 2 depict an exemplary embodiment of a machine, such as a motor grader 10. The motor grader 10 may be used primarily as a finishing tool to sculpt a surface 11 of earth or other material to a final arrangement. Rather than moving large quantities of earth in the direction of travel like other machines, such as a bulldozer, the motor grader 10 typically moves relatively small quantities of earth from side to side. In other words, the motor grader 10 typically moves earth across the area being graded, not straight ahead. While the exemplary embodiment is shown in the form of the motor grader 10, it will be appreciated that the current systems and methods may be used with other types of machines that may benefit from the advantages taught herein.

More specifically, the motor grader 10 includes a front frame 12, a rear frame 14, and a motor grader implement, such as a blade 16. The front and rear frames 12 and 14 are supported by ground engaging units, such as a set of rear wheels 18a and a set of front wheels 18b. An operator cab 20, containing many controls 19 necessary to operate the motor grader 10, is mounted on the front frame 12. A primary power source 21 may be supported by the rear frame 14 and operably coupled through a transmission 23 to the rear wheels 18a for primary machine propulsion. The primary power source 21 may be, for example, a diesel engine, a gasoline engine, a natural gas engine, or any other engine known in the art. The primary power source 21 may also be an electric motor linked to a fuel cell, a capacitive storage device, a battery, or another source of power known in the art. The transmission may be a mechanical transmission, hydraulic transmission, or any other transmission type known in the art. The transmission may be operable to produce multiple output speed ratios (or a continuously variable speed ratio) between the power source and driven traction devices.

A vehicle steering system 17 includes steering actuators 13 that turn the front wheels 18b. The vehicle steering system 17 may also include a wheel lean actuator 15 that tilts the front wheels 18b from left to right.

The blade 16, alternatively referred to as a moldboard, is used to move earth. The blade 16 is mounted on a linkage assembly, shown generally at 22. The linkage assembly 22 allows the blade 16 to be moved to a variety of different positions relative to the motor grader 10.

The linkage assembly 22 may include a drawbar 24 mounted to the front frame 12 by a ball joint. The position of the drawbar 24 is controlled by three hydraulic actuators, commonly referred to as a right lift actuator 28, a left lift actuator 30, and a center shift actuator 32. A coupling, shown generally at 34, connects the three actuators 28, 30, and 32 to the front frame 12. The coupling 34 can be moved during blade repositioning but is fixed stationary during earthmoving operations. The height of the blade 16 with respect to the surface 11 below the motor grader 10, commonly referred to as blade height, is controlled primarily with the right and left lift actuators 28 and 30. The right and left lift actuators 28 and 30 are connected to right 31 and left 33 portions of the blade 16 respectively. The actuators 28, 30 can be controlled independently and, thus, used to angle a bottom cutting edge 35 of the blade 16 relative to the surface 11. The center shift actuator 32 is used primarily to side shift the drawbar 24, and all the components mounted to the end of the drawbar including the blade 16, relative to the front frame 12. This side shift is commonly referred to as drawbar side shift or circle center shift.

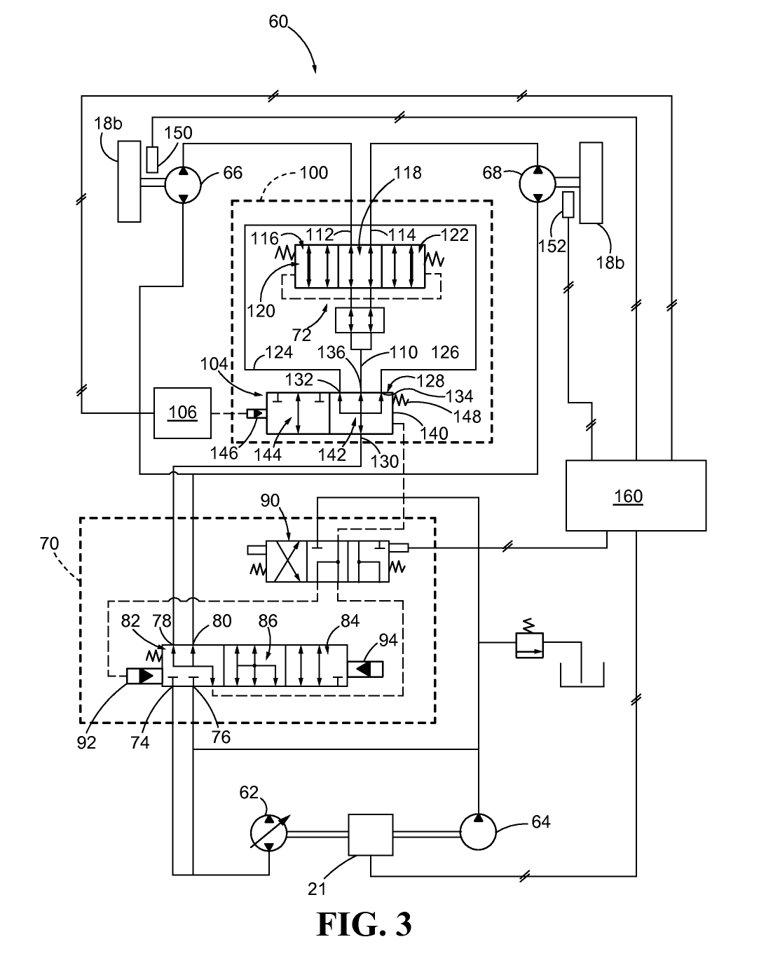

The drawbar 24 includes a large, flat plate, commonly referred to as a yoke plate 36, as shown in FIGS. 2 and 3. Beneath the yoke plate 36 is a large gear, commonly referred to as a circle 38. The circle 38 is rotated by a hydraulic motor, commonly referred to as a circle drive 40, as shown in FIG. 1. The rotation of the circle 38 by the circle drive 40, commonly referred to as circle turn, pivots the blade 16 about a first vertical axis V1 fixed to the drawbar 24 to establish a blade cutting angle. The blade cutting angle is defined as the angle of the blade 16 relative to the front frame 12. At a zero degree blade cutting angle, the blade 16 is aligned at a right angle to the front frame 12. In FIG. 2, the blade 16 is shown set at a zero degree blade cutting angle.

The blade 16 is mounted to a hinge on the circle 38 with a bracket. A blade tip actuator 46 is used to pitch the bracket forward or rearward. In other words, the blade tip actuator 46 is used to tip or tilt a top edge 47 of the blade 16 ahead of or behind the bottom cutting edge 35 of the blade 16. The position of the top edge 47 of the blade 16 relative to the bottom cutting edge 35 of the blade 16 is commonly referred to as blade tip.

The blade 16 is mounted to a sliding joint in the bracket allowing the blade 16 to be slid or shifted from side to side relative to the bracket or the circle 38. This side-to-side shift is commonly referred to as blade side shift. A side shift actuator 50 is used to control the blade side shift.

Referring specifically to FIG. 2, a right articulation actuator, shown generally at 52, is mounted to the right side of the rear frame 14 and a left articulation actuator, shown generally at 54, is mounted to the left side of the rear frame 14. The right and left articulation actuators 52 and 54 are used to rotate the front frame 12 about a second vertical axis V2 shown in FIG. 1. The axis V2 is commonly referred to as the articulation axis. In FIG. 2, the motor grader 10 is shown positioned in a neutral or zero articulation angle.

FIG. 3 illustrates a wheel assist drive system 60 that may be used to drive the front wheels 18b. The wheel assist drive system 60 may include a primary pump 62 operably coupled to the primary power source 21 for circulating hydraulic fluid through the system. A pilot pump 64 may also be provided to help actuate various hydraulic components of the system.

The wheel assist drive system 60 may be configured to hydraulically drive the front wheels 18b when desired. In the illustrated embodiment, first and second wheel motors 66, 68 are operably coupled to the front wheels 18b. Hydraulic fluid supplied by the primary pump 62 flows through the first and second wheel motors 66, 68 to rotate the associated front wheels 18b, thereby to operate the machine in all-wheel drive mode. The flow of hydraulic fluid to the first and second wheel motors 66, 68 may be selectively controlled by a free-wheeling valve 70 and a flow divider valve 72, as described in greater detail below.

The free-wheeling valve 70 is provided to permit or block fluid flow to the first and second wheel motors 66, 68, thereby controlling whether the machine operates in rear wheel drive or all-wheel drive. As best shown in FIG. 3, the free-wheeling valve 70 may be generally configured as a spool valve having first and second inlets 74, 76 fluidly communicating with the primary pump 62 and first and second outlets 78, 80 fluidly communicating with the first and second wheel motors 66, 68. The free-wheeling valve 70 may have at least the positions or modes which are schematically illustrated in FIG. 3. In a first or free-wheeling mode 82, the free-wheeling valve 70 is at its right-most position as shown in FIG. 3. In this position, fluid flow from the primary pump 62 is prevented from flowing out of the outlets 78, 80, thereby to block flow to the first and second wheel motors 66, 68. In a second or drive assist mode 84, the free-wheeling valve 70 is shifted to its left-most position to permit hydraulic fluid to flow to the first and second outlets 78, 80. In one embodiment, as shown, a third or transition mode 86 may also be provided between the free-wheeling and drive assist modes to smooth the transition between drive assist mode 84 and free-wheeling mode 82.

An electrohydraulic spool valve 90 may be provided to control position of the free-wheeling valve 70. As schematically shown in FIG. 3, the electrohydraulic spool valve 90 fluidly communicates with pilot pressure ports 92, 94 provided on opposite ends of the free-wheeling valve 70. The electrohydraulic spool valve 90 may be shifted to control hydraulic fluid pressures communicated to the pilot pressure ports 92, 94, thereby to shift the free-wheeling valve 70 to the desired mode.

The wheel assist drive system 60 may further include a flow divider assembly 100 that generally includes the flow divider valve 72, a bypass valve 104, and an on/off electrohydraulic valve 106.

The flow divider valve 72 may be used to execute traction control, thereby to reduce wheel slip. Accordingly, the flow divider valve 72 may include a flow divider inlet 110 fluidly communicating with first and second flow divider outlets 112, 114. The first flow divider outlet 112 fluidly communicates with the first wheel motor 66 while the second flow divider outlet 114 fluidly communicates with the second wheel motor 68. A flow divider valve member 116 is disposed between the flow divider inlet 110 and the first and second flow divider outlets 112, 114 and may have three positions. In a first or equal flow mode 118, a substantially equal flow of hydraulic fluid is provided to the first and second wheel motors 66, 68, as shown in FIG. 3. The flow divider valve member 116 may be shifted to the right to a first flow mode 120, in which a greater flow of fluid is provided to the first wheel motor 66. Additionally, the flow divider valve member 116 may be shifted to the left to a second flow mode 122, in which a greater flow of fluid is provided to the second wheel motor 68. Operation of the flow divider valve member 116 may be controlled to equalize hydraulic fluid pressure provided to the first and second flow divider outlets 112, 114, thereby to provide traction control.

The flow divider valve 72 may further include a bypass assembly for selectively bypassing the flow divider valve member 116 and deactivating traction control. The bypass assembly may include first and second bypass conduits 124, 126 fluidly communicating around the flow divider valve member 116 to the first and second wheel motors 66, 68, respectively. Additionally, the bypass assembly may include a bypass valve 128 having a bypass inlet 130 fluidly communicating with the first free-wheeling valve outlet 78, a first bypass outlet 132 fluidly communicating with the first bypass conduit 124, a second bypass outlet 134 fluidly communicating with the second bypass conduit 126, and a third bypass outlet 136 fluidly communicating with the flow divider inlet 110.

A bypass valve member 140 is disposed between the bypass inlet 130 and the bypass outlets 132, 134, 136, and is movable between a bypass mode 142 and a flow dividing mode 144. In the bypass mode 142 shown in FIG. 3, the bypass inlet 130 fluidly communicates with the first and second bypass outlets 132, 134 to route hydraulic fluid around the flow divider valve member 116 and disable traction control. In the illustrated embodiment, the bypass inlet 130 also fluidly communicates with the third bypass outlet 136, however only a limited amount of hydraulic fluid may flow through the flow divider valve member 116. In the flow dividing mode 144, the bypass inlet 130 fluidly communicates only with the third bypass outlet 136, so that substantially all of the hydraulic fluid is routed through the flow divider valve member 136 to provide traction control.

The on/off electrohydraulic valve 106 is provided to actuate the bypass valve 104 between the bypass and flow dividing modes 142, 144. As schematically shown in FIG. 3, the on/off electrohydraulic valve 106 fluidly communicates with a pilot pressure port 146 provided on an opposite end of the bypass valve member 140 from a spring 148. The on/off electrohydraulic valve 106 may be shifted to control hydraulic fluid pressure communicated to the pilot pressure port 146, thereby to shift the bypass valve member 140 to the desired mode.

The wheel assist drive system 60 may further include feedback devices to provide information usable in the control of the system. For example, first and second wheel speed sensors 150, 152 may be associated with the first and second wheel motors 66, 68 and or front wheels 18b and configured to provide feedback indicative of wheel speed. Other sensors or feedback devices may be provided to provide additional information.

A controller 160 may be provided to control operation of the wheel assist drive system 60. For example, the controller 160 may be operably coupled to the electrohydraulic spool valve 90 and on/off electrohydraulic valve 106 to selectively control the modes of operation of the free-wheeling valve 70 and bypass valve member 140. Additionally, the controller 160 may be operably coupled to the first and second wheel speed sensors 150, 152 and the primary power source 21 to receive feedback signals indicative of machine operating parameters or to send control signals to operate one or more machine components. The controller 160 may include drive-assist-logic circuitry, comprising one or more central processing units and one or more memory devices, the one or more memory devices storing instructions that, when executed by the one or more central processing units, cause the drive-assist-logic circuitry to execute the functions described herein.

### INDUSTRIAL APPLICABILITY

The present disclosure is applicable to machines having wheel drive assist systems. Such systems may include a free-wheeling valve to selectively control operation in all-wheel drive mode and a flow divider valve to permit traction control. According to the present disclosure, a bypass valve is provided between the free-wheeling valve and the flow divider valve to selectively rout hydraulic fluid flow either through or around the flow divider valve. More specifically, operation in the bypass mode is used to reduce heat generation and valve modulation losses associated with conventional flow divider valve operation.

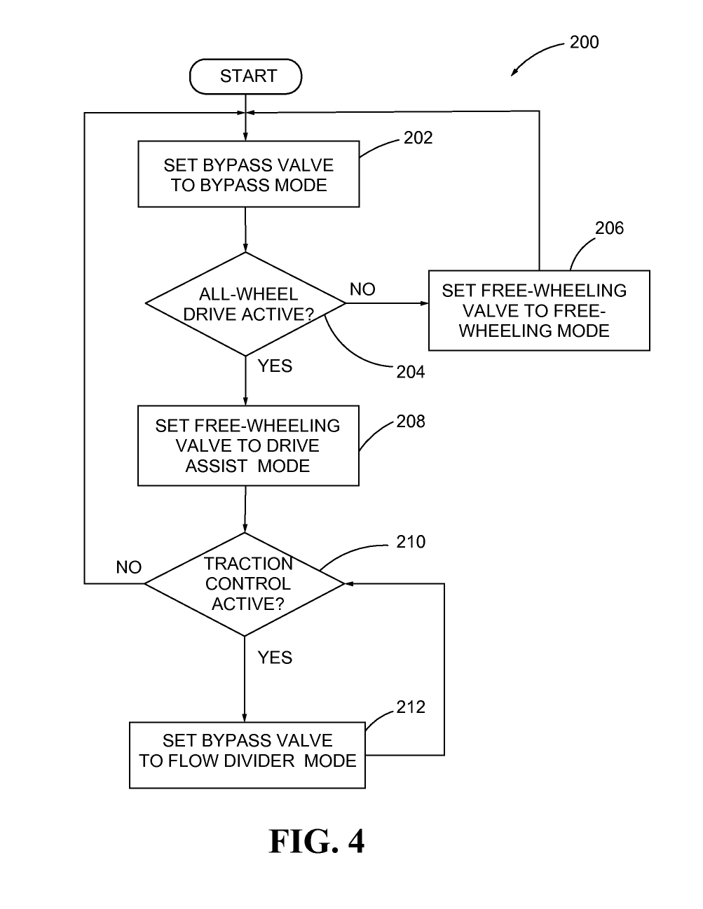

FIG. 4 illustrates by way of flowchart an exemplary process 200 for controlling operation of the wheel assist drive system 60. At stage 202 of the process 200, the bypass valve member 140 is set to the bypass mode 142 and the process 200 continues forward to stage 204.

At stage 204, it is determined whether all-wheel drive is active. All-wheel drive may be activated by user input or control logic residing in the controller 160 or elsewhere. If all-wheel drive is not active, the process continues to stage 206 where the free-wheeling valve 70 is set to the free-wheeling mode 82 and the process 200 returns to stage 202.

If, however, it is determined at stage 204 that all-wheel drive is active, the process 200 continues forward to stage 208, where the free-wheeling valve 70 is actuated to the drive assist mode 84 at stage 208. This may be accomplished, for example, by actuating the electrohydraulic spool valve 90 to provide pilot pressures that shift the free-wheeling valve 70 to the drive assist mode 84.

The process 200 then continues to stage 210, where it is determined whether traction control is active. As with all-wheel drive, traction control may be activated by user input or control logic residing in the controller 160 or elsewhere. If traction control is not active, the process 200 returns to stage 202 and the bypass valve member 140 remains in bypass mode 142.

Otherwise, if it is determined that traction control is active, the process 200 continues forward to stage 212 at which the bypass valve member 140 is set to the flow dividing mode 144. Setting the bypass valve member 140 to the flow dividing mode 144 may be accomplished, for example, by actuating the on/off electrohydraulic valve 106 to provide a pilot pressure sufficient to overcome spring 148, thereby shifting the bypass valve member 140 to the flow dividing mode 144. The process 200 then returns back to stage 210 to again determine if fraction control remains active. When traction control is no longer active, then the process will return to stage 202 at which point the bypass valve member 140 will be returned to the bypass mode 142.

According to the process 200, operation of the bypass valve member 140 is predicated on the status of the free-wheeling valve 70. More specifically, if the free-wheeling valve 70 is in the free-wheeling mode 82, the bypass valve member 140 may be operated only in the bypass mode 142. Thus, the bypass valve member 140 may be operated in the flow dividing mode 144 only when the free-wheeling valve 70 is in the drive assist mode 84. In this way, hydraulic circuit inefficiencies and excessive heat generation are reduced.

Control of the wheel assist drive system 60 may be executed via the computerized execution of instructions stored on a nontransitory computer-readable medium or memory, e.g., a disc drive, flash drive, optical memory, ROM, etc. The executing entity may be one or more controllers and may be separate from or part of one or more existing controllers such as one or more engine controllers and/or transmission controllers.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of controlling front wheel assist and traction control on a machine having first and second wheel motors and a primary pump for circulating a hydraulic fluid, the method comprising:
providing a flow divider valve having a flow divider inlet fluidly communicating with first and second flow divider outlets, the first flow divider outlet fluidly communicating with the first wheel motor and the second flow divider outlet fluidly communicating with the second wheel motor;
providing a bypass valve upstream of the flow divider valve, the bypass valve having a bypass mode, in which at least a portion of hydraulic fluid is communicated around the flow divider valve to the first and second wheel motors, and a flow dividing mode in which the hydraulic fluid is communicated through the flow divider valve to the first and second wheel motors;
providing a free-wheeling valve upstream of the bypass valve, the free-wheeling valve having a free-wheeling mode, in which fluid communication is prevented between the primary pump and the first and second wheel motors, and a drive assist mode, in which the primary pump fluidly communicates with the first and second wheel motors;
determining an activation status of the free-wheeling valve;
operating the bypass valve in the bypass mode when the free-wheeling valve is in the free-wheeling mode; and
operating the bypass valve in either of the bypass mode and the flow dividing mode when the free-wheeling valve is in the drive assist mode.

2. The method of claim 1, in which the machine comprises a motor grader.

3. The method of claim 2, in which the motor grader comprises a pair of rear wheels and a pair of front wheels, and in which the first and second wheel motors are coupled to the pair of front wheels.

4. The method of claim 3, in which the motor grader further includes a primary power source, and in which the primary pump is operably coupled to the primary power source.

5. The method of claim 4, in which the pair of rear wheels is linked to the primary power source by a transmission.

6. The method of claim 1, further comprising, when the free-wheeling valve is in the drive assist mode, determining whether traction control is active and operating the bypass valve in the flow dividing mode only when traction control is active.

7. A method of controlling front wheel assist and traction control on a machine having first and second wheel motors and a primary pump for circulating a hydraulic fluid, the method comprising:
providing a flow divider valve having a flow divider inlet fluidly communicating with first and second flow divider outlets, the first flow divider outlet fluidly communicating with the first wheel motor and the second flow divider outlet fluidly communicating with the second wheel motor;
providing a bypass valve upstream of the flow divider valve, the bypass valve having a bypass mode, in which at least a portion of hydraulic fluid is communicated around the flow divider valve to the first and second wheel motors, and a flow dividing mode in which the hydraulic fluid is communicated through the flow divider valve to the first and second wheel motors;
providing a free-wheeling valve upstream of the bypass valve, the free-wheeling valve having a free-wheeling mode, in which fluid communication is prevented between the primary pump and the first and second wheel motors, and a drive assist mode, in which the primary pump fluidly communicates with the first and second wheel motors;
initially setting the bypass valve to the bypass mode;
determining an activation status of the free-wheeling valve; and
operating the bypass valve the flow dividing mode when the free-wheeling valve is in the drive assist mode and traction control is active.

8. The method of claim 7, in which the machine comprises a motor grader.

9. The method of claim 8, in which the motor grader comprises a pair of rear wheels and a pair of front wheels, and in which the first and second wheel motors are coupled to the pair of front wheels.

10. The method of claim 9, in which the motor grader further includes a primary power source, and in which the primary pump is operably coupled to the primary power source.

11. The method of claim 10, in which the pair of rear wheels is linked to the primary power source by a transmission.

12. The method of claim 7, further comprising, when the free-wheeling valve is in the drive assist mode, determining whether traction control is active and operating the bypass valve in the flow dividing mode only when traction control is active.

13. A drive assist system for a machine having a primary pump and first and second ground-engaging members, the drive assist system comprising:
a hydraulic first wheel motor operably coupled to the first ground-engaging member;
a hydraulic second wheel motor operably coupled to the second ground-engaging member;
a free-wheeling valve disposed between the primary pump and the first and second wheel motors, the free-wheeling valve operable between a free-wheeling mode blocking fluid flow from the primary pump to the first and second wheel motors, and a drive assist mode permitting fluid flow from the primary pump to the first and second wheel motors;
a flow divider valve disposed between the free-wheeling valve and the first and second wheel motors;
a first bypass conduit fluidly communicating with the first wheel motor and around the flow divider valve member;
a second bypass conduit fluidly communicating with the second wheel motor and around the flow divider valve member;
a bypass valve disposed between the flow divider valve and the free-wheeling valve, the bypass valve having a flow dividing mode permitting fluid communication between the free-wheeling valve and the flow divider valve, and a bypass mode permitting fluid communication between the free-wheeling valve and the first and second bypass conduits; and
a controller operably coupled to the free-wheeling valve and the bypass valve, the controller being configured to:
determine an activation status of the free-wheeling valve;
operate the bypass valve member in the bypass mode when the free-wheeling valve is in the free-wheeling mode; and
operate the bypass valve member in either of the bypass mode and the flow dividing mode when the free-wheeling valve is in the drive assist mode.

14. The drive assist system of claim 13, in which the machine comprises a motor grader.

15. The drive assist system of claim 14, in which the first and second ground engaging units comprise a pair of front wheels, the motor grader further comprising a pair of rear wheels.

16. The drive assist system of claim 15, in which the motor grader further includes a primary power source, and in which the primary pump is operably coupled to the primary power source.

17. The drive assist system of claim 16, in which the pair of rear wheels is linked to the primary power source by a transmission.

18. The drive assist system of claim 13, in which the controller is further configured to, when the free-wheeling valve is in the drive assist mode, determine whether traction control is active and operates the bypass valve in the flow dividing mode only when traction control is active.
